(19) United States
(12) Patent Application Publication
(10) Pub. No.: US 2010/0142430 A1
(43) Pub. Date: Jun. 10, 2010

(54) MULTIMEDIA DATA SERVICE APPARATUS OF MOBILE COMMUNICATION SYSTEM SUPPORTING MULTICAST AND MULTICAST SERVICE ACTIVATION AND DEACTIVATION METHODS FOR MULTIMEDIA DATA SERVICE

(75) Inventors: Ho-choong CHO, Daejeon-si (KR); Eun-hee HYUN, Daejeon-si (KR); Dae-ik KIM, Daejeon-si (KR); Hyun-suk ROH, Daejeon-si (KR); Sang-ho LEE, Daejeon-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/630,166

(22) Filed: Dec. 3, 2009

(30) Foreign Application Priority Data
Dec. 8, 2008 (KR) 10-2008-0124168
Mar. 9, 2009 (KR) 10-2009-0019953

(51) Int. Cl. H04H 20/71; H04L 12/56; H04W 12/06; H04W 88/16

(52) U.S. Cl. 370/312; 370/401; 455/411

(57) ABSTRACT

A multimedia data service apparatus of a mobile communication system for supporting multicast and multicast service activation and deactivation methods for a multimedia data service used by the mobile communication system are provided. Information for mobility management is searched for according to a multimedia data service join request from a packet data network gateway of the mobile communication system, and multimedia data is multicasted to a user equipment. Accordingly, a multicast service can be provided in a system of 3^{rd} Generation Partnership Project (3GPP) Release 7 or later.

### CROSS REFERENCE TO RELATED APPLICATIONS

This application claims the benefit under 35 U.S.C. §119(a) of Korean Patent Application Nos. 10-2008-0124168, filed on Dec. 8, 2008, and 10-2009-0019953, filed on Mar. 9, 2009, the disclosures of which are incorporated by reference herein for all purposes.

### BACKGROUND

1. Field

The following description relates to a multimedia data service technology, and more particularly, to a multimedia data service apparatus of a mobile communication system supporting multicast and a multicast service activation and deactivation method for a multimedia data service of the mobile communication system.

2. Description of the Related Art

In line with an increase in needs for services to transmit the same multimedia data to a plurality of users in a mobile communication network, 3^{rd} Generation Partnership Project (3GPP) Release 6 standards have recently defined Multimedia Broadcast/Multicast Service (MBMS) and have developed its standardization.

A 3GPP MBMS service is to transmit multimedia data such as audio data, video data, still images, text data, and files to a plurality of users through a unidirectional bearer, and is advantageous for efficient use of wireless and wired resources.

Universal Mobile Telecommunications System (UMTS), which is one of the 3GPP release 6 technologies, comprises a user equipment (UE), a radio network controller (RNC), a serving general packet radio service (GPRS) support node (SGSN), and a gateway GPRS support node (GGSN), each node includes a new function for supporting an MBMS service, and a Broadcast and Multicast Service Center (BM-SC) node is newly provided.

However, 3GPP Release 7 and later standards introduce a 3GPP Long Term Evolution (LTE) system for effectively providing high-speed multimedia service. The 3GPP LTE system consists of a UE acting as a terminal, an evolved NodeB (eNodeB) acting as a base station, and an evolved packet core (EPC) acting as a core network.

EPC which is a core network consists of mobility management entity (MME) for mobility and session management, a serving gateway (serving GW), and a packet data network gateway (PDN GW) for data processing. In addition, an MBMS session control function is added to an MME node in order to provide an MBMS service, and an additional gateway, MBMS GW, is added for MBMS data processing.

MBMS standards which have been applied to systems since 3GPP Release 7 define a new architecture, evolved Multimedia Broadcast/Multicast Service (eMBMS), to provide an MBMS service. Moreover, a new function is added to each of the UE, the eNodeB and the MME to provide an eMBMS service, and an MBMS GW and an evolved Broadcast and Multicast Service center (eBM-SC) node are newly specified.

Conventional eMBMS standards support only a broadcast mode for providing a broadcasting service, but not a multicast mode for group communications between UEs, and therefore definition of the multicast mode in the eMBMS standards is additionally required.

### SUMMARY

Thus, a multimedia data service technology of a mobile communication system for supporting a multicast mode and multicast service activation and deactivation technologies for the multimedia data service are being researched.

Accordingly, in one general aspect, there is provided a multimedia data service apparatus suitable for a mobile communication system supporting multicast, the multimedia data service apparatus searching for information for mobility management and multicasting multimedia data to a user equipment according to a multimedia data service join request from a packet data network gateway.

In another general aspect, there is provided a multimedia data service apparatus suitable for a mobile communication system supporting multicast, the multimedia data service apparatus activating multicast service according to a multimedia data service join request from a packet data network gateway of the mobile communication system.

In still another general aspect, there is provided a multimedia data service apparatus suitable for a mobile communication system supporting multicast, the multimedia data service apparatus deactivating multicast service according to a multimedia data service termination request from a packet data network gateway of the mobile communication system.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating an exemplary multimedia data service apparatus in a mobile communication system for supporting a multicast.

FIG. 2 is a flowchart illustrating an exemplary multicast service activation method for a multimedia data service of the mobile communication system.

FIG. 3 is a flowchart illustrating an exemplary multicast service deactivation method for a multimedia data service of a mobile communication system.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

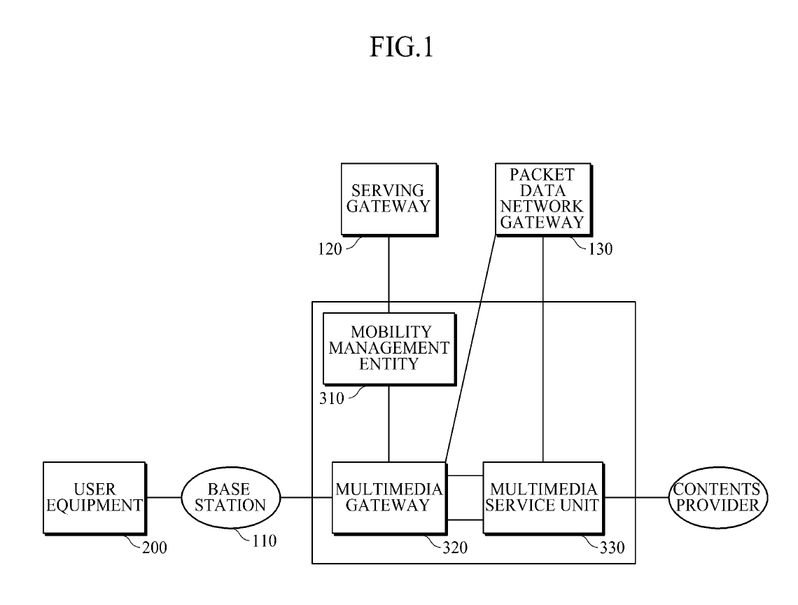

FIG. 1 is a block diagram illustrating an exemplary multimedia data service apparatus 300 in a mobile communication system 100 for supporting multicast. Referring to FIG. 1, the mobile communication system 100 includes a base station 110, a mobility management entity 310, a serving gateway 120, and a packet data network gateway 130.

The base station 110 manages radio resources, and processes wired/wireless protocol for communications with other nodes. For example, the base station 11 may be an evolved NodeB (eNodeB) in a 3^{rd} Generation Partnership Project (3GPP) long term evolution (LTE) system.

The mobility management entity 310 manages mobility and session of a user equipment 200, and performs multimedia session control. For example, the mobility management entity 310 may be a mobility management entity (MME) in a 3GPP LTE system.

The serving gateway 120 controls mobility between the base stations or mobility between heterogeneous networks and wired bearers. For example, the serving gateway 120 may be a serving gateway (GW) in a 3GPP LTE system.

The packet data network gateway 130 controls mobility between heterogeneous networks and wired bearers. For example, the packet data network gateway 130 may be a packet data network gateway (PDN GW) in a 3GPP LTE system.

The multimedia data service apparatus 300 constitutes the mobile communication system 100 for supporting multicast, and includes the mobility management entity 310 for multimedia session control, a multimedia gateway 320, and a multimedia service unit 330.

The mobility management entity 310 manages the mobility of the user equipment 200 and controls sessions for multimedia data.

The multimedia gateway 320 receives a multimedia data service join request from the packet data network gateway 130 of the mobile communication system 100, and multicasts multimedia data managed by the multimedia service unit 330 to the user equipment 200 according to a multicast session control of the mobility management entity 310.

The multimedia gateway 320 receives a multimedia data service termination request for a particular user equipment from the packet data network gateway 130, and terminates multimedia data service for the particular user equipment by instructing the multimedia service unit 330. For example, the multimedia gateway 320 may be a Multimedia Broadcast/Multicast Service (MBMS) GW in a GPP Release 7 or later system.

The multimedia service unit 330 performs multimedia data service management including storing and transferring of multimedia data provided from content providers, and user authentication for the multimedia data service. For example, the multimedia service unit 330 may be an evolved Broadcast and Multicast Service Center (eBM-SC) in a 3GPP Release 7 or later system.

In a 3GPP MBMS service, various forms of multimedia data such as audio, video, still image, text, and files are casted to a plurality of user equipments through a unidirectional bearer, and thus the multimedia data service join request or the multimedia data service termination request from the user equipment should be received through the packet data network gateway 130 of the mobile communication system 100.

The packet data network gateway 130 of the mobile communication system 100 transmits the multimedia data service join request or the multimedia data service termination request for a particular user equipment, the multimedia gateway 320 receives the request, and then multicasting of the multimedia data for the corresponding user equipment is performed or terminated under control of the multimedia service unit 330.

To this end, an interface is required between the multimedia gateway 320 and the packet data network gateway 130 of the mobile communication system 100 to transmit and receive the data service join request. For example, a multimedia data service join request may include an Internet protocol (IP) address or International Mobile Station Identity (IMSI) of a user equipment which requests joining the multimedia data service.

Therefore, the exemplary multimedia data service apparatus 300 receives the data service join request from the packet data network gateway 130 of the mobile communication system 100 through the multimedia gateway 320 and multicasts multimedia data stored in the multimedia service unit 330 to the corresponding user equipment 200 through a multicast activation process between the multimedia service unit 330 and the mobility management entity 310.

The multimedia data service apparatus 300 receives the multimedia data service termination request from the packet data network gateway 130 of the mobile communication system 100 through the multimedia gateway 320, and terminates the multicasting of the multimedia data for the corresponding user equipment 200 through a multicast deactivation process between the multimedia service unit 330 and the mobility management entity 310.

Accordingly, it is possible to support the multicast for evolved multimedia broadcasting and multicast service in the 3GPP Release 7 or later system, so that multimedia contents in various forms can be provided to a plurality of users.

In another example, the multimedia gateway 320 may be configured to receive a multimedia data service join request from the packet data network gateway 130 of the mobile communication system 100 and to issues a request to the multimedia service unit 330 for user authorization with respect to a user equipment which requests joining the multimedia data service. In this case, the multimedia data service join request may include an IP address or IMSI of the corresponding user equipment.

That is, it is verified whether or not a user equipment which requests joining the multimedia data service is authenticated to receive the multimedia service. Through the above verification process, the user equipment may obtain an accurate access point name (APN) to be provided with the multimedia data service.

For example, according to a user authorization request by the multimedia gateway 320, the multimedia service unit 330 may verify whether or not a user equipment which requests joining the multimedia data service is authenticated to receive the multimedia data service by comparing an IP address or IMSI of the user equipment with IP addresses or IMSIs of authenticated user equipments previously stored.

In another example, the multimedia gateway 320 may be configured to transmit a user authorization success notification message to the mobility management entity 310 when the multimedia service unit 330 verifies that the user equipment is authenticated to receive the multimedia data service.

In this case, the mobility management entity 310 may be configured to search for information of the base station 110 to which the user equipment 200 that requests joining the multimedia data service is connected when the mobility management entity 310 receives the user authorization success notification message from the multimedia gateway 320.

The mobility management entity 310 transmits multicast service activation request information to the user equipment 200 which requests the multimedia data service with reference to the information of the base station 110 to which the user equipment 200 is accessed.

Then, the user equipment 200 which receives the multicast service activation request information notifies of a multicast service activation start, and the mobility management entity 310 generates multimedia data service information, requests the base station 110 for connection with the user equipment 200, and transmits multicast service activation authentication information to the connected user equipment 200 according to the multicast service activation start notification, so that the multicast service is activated and multimedia data can be multicasted to the user equipment 200. The multimedia service activation process will be described later in detail.

In another example, the multimedia gateway 320 may be configured to receive a multimedia data service termination request for a particular user equipment 200 from the packet data network gateway 130 of the mobile communication system 100 and to instruct the multimedia service unit 330 to terminate the multimedia data service for the corresponding user equipment 200. Information of the multimedia data service termination request may include an IP address or IMSI of the user equipment 200 that requests the multimedia data service termination.

Then, the multimedia service unit 330 which receives the multimedia data service termination request issues a request to the multimedia gateway 320 to remove a connection with the user equipment 200, and in response to the request, the multimedia gateway 320 transmits information of a user equipment deactivation request to the mobility management entity 310.

According to the user equipment deactivation request from the multimedia gateway 320, the mobility management entity 310 transmits information of a multicast service deactivation request to the corresponding user equipment 200. Then, in response to the user equipment's 200 response to the multicast service deactivation request, the mobility management entity 310 requests the base station 110 to terminate a connection with the user equipment 200, and deletes multimedia data service information of the user equipment 200 whose connection is terminated, such that the multimedia data multicasting to the user equipment 200 can be terminated. The multimedia data service deactivation process will be described later in detail.

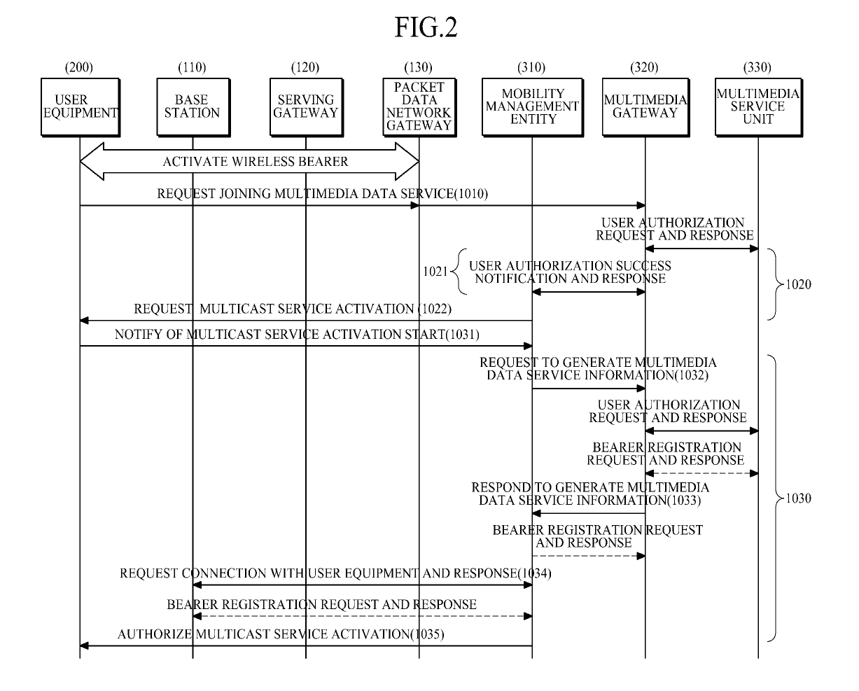

Hereinafter, the multimedia data service activation process of the exemplary multimedia data service apparatus of the mobile communication system for supporting multicast will be described with reference to FIG. 2. FIG. 2 is a flowchart illustrating an exemplary multicast service activation method of the mobile communication system for a multimedia data service.

As illustrated in FIG. 2, in response to a data service join request from a user equipment 200, at 1010, a multimedia data service apparatus 300 receives information of the multimedia data service join request from a packet data network gateway 130. The information of the multimedia data service join request may include an IP address or IMSI of the user equipment 200 that requests joining the multimedia data service.

For example, at 1010, the multimedia data service apparatus 300 may receive information of the multimedia data service join request from the packet data network gateway 130 of the mobile communication system 100 through the multimedia gateway 320.

The multimedia data service apparatus 300 which has received the information of the multimedia data service join request transmits, at 1020, information of a multicast service activation request to the user equipment 200 that requests joining the multimedia data service.

More specifically, at 1021, the multimedia data service apparatus 300 which has received the information of the multimedia data service join request, processes user authorization with respect to the user equipment 200 which requests joining the multimedia data service.

For example, the multimedia data service apparatus 300 requests the multimedia service unit 330 for the user authorization through the multimedia gateway 320, and in response to the request, the multimedia service unit 330 verifies whether the user equipment 200 is authenticated to receive the multimedia data service by comparing the IP address or IMSI of the user equipment 200 with previously stored IP addresses or IMSIs of authenticated user equipments, and transmits the verification result to the multimedia gateway 320, and then the multimedia gateway 320 notifies the mobility management entity 310 of the success of user authorization and receives the response of the notification, so that performing of user authorization/notification is completed.

When the user authorization/notification is successfully processed at 1021, the multimedia data service apparatus 300, at 1022, transmits the information of the multicast service activation request to the user equipment 200 that requests joining the multimedia data service. For example, the multicast service activation request is transmitted through the mobility management entity 310.

When the user equipment 200, which receives the multicast service activation request at 1020, notifies of the start of the multicast service activation, the multimedia data service apparatus 300 processes the multicast service activation at 1030.

More specifically, when the user equipment 200 which has received the multicast service activation request notifies of the start of the multicast service activation, the multimedia data service apparatus 300 receives information of the multicast service activation start notification from the user equipment 200 through, for example, the mobility management entity 310 at 1031.

Once the multicast service activation start notification is received, the multimedia data service apparatus 300 requests the multimedia gateway 320 to generate multimedia data service information through, for example, the mobility management entity 310 at 1032. In response to the request, the multimedia gateway 320 generates multimedia data service information at 1033.

When the generation of the multimedia data service information is completed through 1032 and 1033, the multimedia data service apparatus 300 requests the base station 110 to connect with the user equipment 100 through, for example, the mobility management entity 310 at 1034.

Once the user equipment 200 is connected to the base station 110 according to the connection request at 1034, the multimedia data service apparatus 300 transmits multicast service activation authentication information to the user equipment 200 connected through, for example, the mobility management entity 310 at 1035.

In addition, as shown with dotted lines in FIG. 2, at 1030, bearer registration may be performed if the user equipment 200 which requests joining the multimedia data service is not bearer connected with the multimedia service apparatus 300.

Accordingly, the multimedia data service apparatus 300 can activate the multicast service according to the multimedia data service join request from the packet data network gateway 130 of the mobile communication system for supporting multicast, and thus the multimedia data can be multicasted to the user equipment 200.

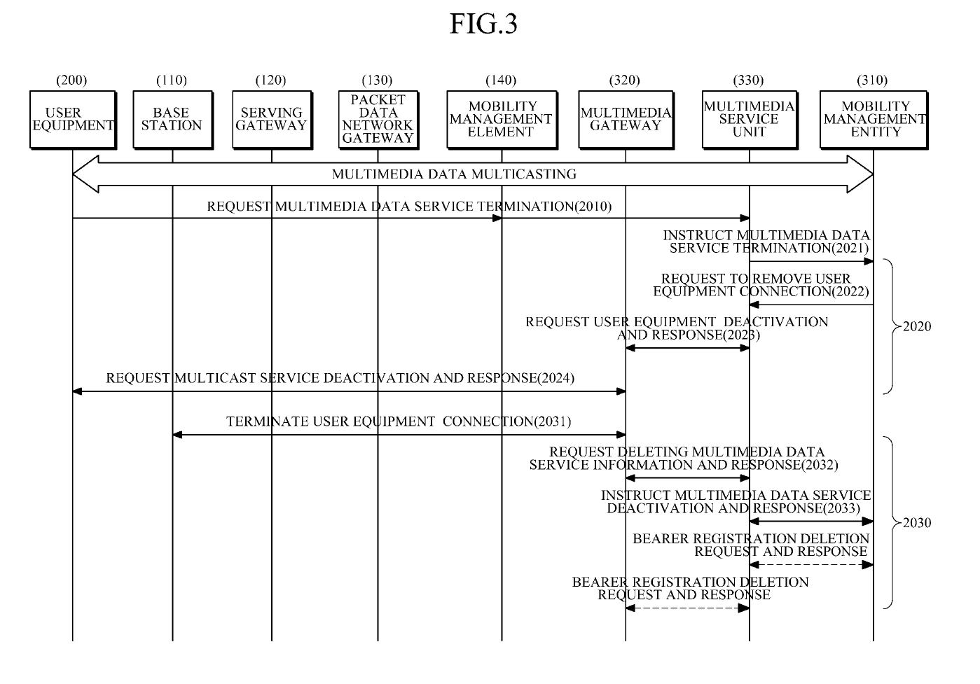

Hereinafter, a multimedia data service deactivation process by the exemplary multimedia data service apparatus will be described in detail with reference to FIG. 3. FIG. 3 is a flowchart illustrating an exemplary multicast service deactivation method for a multimedia data service of a mobile communication system.

As shown in FIG. 3, in response to a multimedia data service termination request from a user equipment 200, a multimedia data service apparatus 300 receives information of the multimedia data service termination request for the particular user equipment 200 from a packet data network gateway 130 of the mobile communication system at 2010. In this case, the information of the multimedia data service termination request may include an IP address or IMSI of the user equipment 200 that requests the multimedia data service termination.

For example, the multimedia data service apparatus 300 may receive the information of the multimedia data service termination request from the packet data network gateway 130 of the mobile communication through a multimedia gateway 320 at 2010.

When receiving the information of the multimedia data service termination request at 2010, the multimedia data service apparatus 300 terminates the multimedia data service for the corresponding user equipment 200, and transmits information of a multicast service deactivation request to the user equipment 200 at 2020.

As a detailed example, when the multimedia data service apparatus 300 instructs a multimedia service unit 330 to terminate the multimedia data service for the user equipment 200 through a multimedia gateway 320 at 2021, the multimedia service unit 330 requests the multimedia gateway 320 to remove a connection with the user equipment 200 at 2022, and in response to the request of the termination, the multimedia gateway 320 issues a user equipment deactivation request to a mobility management entity 310 at 2023. Thereafter, the mobility management entity 310 issues, at 2024, a multicast service deactivation request to the user equipment 200 that has requested the multimedia data service termination.

According to response from the user equipment 200 which has received information of the multicast service deactivation request, the multimedia data service apparatus 300 processes multimedia data service deactivation at 2030.

More specifically, when receiving the response to the multicast service deactivation request from the user equipment 200, the multimedia data service apparatus 300 requests a base station 110 to terminate the connection with the user equipment 200 through, for example, the mobility management entity 310 at 2031.

Then, the multimedia data service apparatus 300 requests, at 2032, the multimedia gateway 320 to delete information of the multimedia data service for the user equipment 200, which is requested to be disconnected from the base station 110 at 2031, through, for example, the mobility management entity 310.

The multimedia gateway 320, which receives the multimedia data service information deletion request at 2032, instructs the multimedia service unit 330 to deactivate the multimedia data service for the user equipment 200 at 2033, and thus the multimedia data service for the corresponding user equipment 200 is eventually deactivated. Then, in response to response to the multimedia data service information deletion request at 2034, the multimedia gateway 320 deletes the information of the multimedia data service for the user equipment 200 at 2034.

In addition, as shown with dotted lines in FIG. 3, bearer registration information for the user equipment 200 which has requested the multimedia data service termination may be deleted at 2030.

Consequently, according to the multimedia data service termination request from the packet data network gateway 130 of the mobile communication system, the multimedia data service apparatus 300 can deactivate the multicast service, such that the multimedia data service multicasted to the user equipment 200 can be terminated.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multimedia data service apparatus suitable for a mobile communication system supporting multicast, the multimedia data service apparatus comprising:
a mobility management entity to manage mobility of a user equipment to receive a multimedia data service and to perform session control for multimedia data;
a multimedia service unit to perform multimedia data service management including multimedia data storage and transmission and to perform user authorization for a multimedia data service; and
a multimedia gateway to receive a multimedia data service join request from a packet data network gateway of the mobile communication system and to multicast data managed by the multimedia service unit to the user equipment according to multicast session control performed by the mobility management entity.

2. The multimedia data service apparatus of claim 1, wherein the multimedia gateway receives information of the multimedia data service join request from the packet data network gateway of the mobile communication system and requests the multimedia service unit for user authorization with respect to the user equipment which requests joining the multimedia data service.

3. The multimedia data service apparatus of claim 2, wherein the information of the multimedia data service participation includes an Internet protocol (IP) address or International Mobile Station Identity (IMSI) of the user equipment which requests joining the multimedia data service.

4. The multimedia data service apparatus of claim 2, wherein the multimedia gateway transmits a user authorization success notification message to the mobility management entity when the multimedia service unit successfully performs the user authorization for the multimedia data service join request.

5. The multimedia data service apparatus of claim 4, wherein when receiving the user authorization success notification message from the multimedia gateway, the mobility management entity searches for information of a base station to which the user equipment that requests joining the multimedia data service is connected.

6. The multimedia data service apparatus of claim 5, wherein the mobility management entity transmits information of a multicast service activation request to the user equipment that requests joining the multimedia data service with reference to the information of the base station.

7. The multimedia data service apparatus of claim 6, wherein the mobility management entity generates multimedia data service information according to a multicast service activation start notification from the user equipment that has received the information of the multicast service activation request, requests the base station to connect with the user equipment, and transmits multicast service activation authentication information to the connected user equipment.

8. The multicast data service apparatus of claim 2, wherein the multimedia gateway receives a multicast data service termination request for a particular user equipment from the packet data network gateway of the mobile communication system and instructs the multimedia service unit to terminate the multimedia data service for the corresponding user equipment.

9. The multicast data service apparatus of claim 8, wherein information of the multimedia data service termination request includes an Internet protocol (IP) address or International Mobile Station Identity (IMSI) of the user equipment which requests termination of the multimedia data service.

10. The multicast data service apparatus of claim 8, wherein the multimedia gateway transmits information of a user equipment deactivation request to the mobility management entity according to a user equipment removal request from the multimedia service unit.

11. The multimedia data service apparatus of claim 10, wherein the mobility management entity transmits information of a multicast service deactivation request to the corresponding user equipment according to the user equipment deactivation request from the multimedia gateway.

12. The multimedia data service apparatus of claim 11, wherein the mobility management entity requests the base station to terminate the connection with the user equipment according to multicast service deactivation response from the user equipment, which has received the information of the multicast service deactivation request, and deletes multimedia data service information of the user equipment whose connection with the base station is terminated.

13. A multicast service activation method for a multimedia data service of a mobile communication system, the multicast service activation method comprising:
receiving, at a multimedia data service apparatus, information of a multimedia data service join request from a packet data network gateway of the mobile communication system;
when receiving the information of the multimedia data service join request, transmitting information of a multicast service activation request from the multimedia data service apparatus to a user equipment which requests joining the multimedia data service.

14. The multicast service activation method of claim 13, wherein the transmitting of the information of the multicast service activation request includes processing user authorization with respect to the user equipment which requests joining the multimedia data service, requesting a mobility management entity to transmit information of a base station to which the user equipment is connected and receiving the information of the base station when the user authorization is successful, and transmitting the information of the multicast service activation request to the user equipment with reference to the received information of the base station.

15. The multicast service activation method of claim 13, further comprising:
processing, at the multimedia data service apparatus, multicast service activation according to multicast service activation start notification from the user equipment which has received the multicast service activation request.

16. The multicast service activation method of claim 15, wherein the processing of the multicast service activation includes receiving information of the multicast service activation start notification from the user equipment, generating multimedia data service information when the information of the multicast service activation start notification is received, requesting the base station to connect with the user equipment when the multimedia data service information is generated, and transmitting multicast service activation authentication information to the user equipment which is connected to the base station.

17. A multicast service deactivation method for a multimedia data service of a mobile communication system, the multicast service deactivation method comprising:
receiving, at a multimedia data service apparatus, information of a multimedia data service termination request for a particular user equipment from a packet data network gateway of the mobile communication system; and
processing, at the multimedia data service apparatus, termination of the multimedia data service for the user equipment according to the multimedia data service termination request, and transmitting information of a multicast service deactivation request to the user equipment.

18. The multicast service deactivation method of claim 17, further comprising:
deactivating, at the multimedia data service apparatus, the multimedia data service according to a multicast data service deactivation response from the user equipment which has received the information of the multicast service deactivation request.

19. The multicast service deactivation method of claim 18, wherein the deactivating of the multimedia data service includes requesting, at the multimedia data service apparatus, the base station to terminate a connection with the user equipment when the multicast data service deactivation response is received from the user equipment, deleting, at the multimedia data service apparatus, multimedia data service information of the user equipment whose connection with the base station is requested to be terminated, and deactivating, at the multimedia data service apparatus, the multimedia data service for the corresponding user equipment when the multimedia data service information of the user equipment whose connection with the base station is requested to be terminated is deleted.
